(19) United States
(12) Patent Application Publication
(10) Pub. No.: US 2018/0346021 A1
(43) Pub. Date: Dec. 6, 2018

(54) METHODS AND APPARATUS FOR VIRTUAL TORSION BAR STEERING CONTROLS

(71) Applicant: Ford Global Technologies, LLC, Dearborn, MI (US)

(72) Inventors: Dexin Wang, Livonia, MI (US); Steven R. El Aile, Sterling Heights, MI (US); Mohamad Wajih Issam Farhat, Dearborn, MI (US); Douglas Scott Rhode, Farmington Hills, MI (US)

(21) Appl. No.: 15/609,804

(22) Filed: May 31, 2017

(51) Int. Cl. B62D 6/00; B62D 5/04

(52) U.S. Cl. CPC B62D 6/008; B62D 6/002; B62D 5/0463

(57) ABSTRACT

Methods and apparatus for virtual torsion bar steering controls are disclosed. A disclosed example apparatus includes a sensor associated with a steering system to measure an operational angle of the steering system, a virtual torsion bar operatively coupled to the steering system, the virtual torsion bar to calculate a control torque based on a request angle and the operational angle, and a torque compensator to control an output torque of the steering system based on the control torque.

### FIELD OF THE DISCLOSURE

This disclosure relates generally to steering systems and, more particularly, to methods and apparatus for virtual torsion bar steering controls.

### BACKGROUND

Known electronic steering systems in vehicles typically employ either a torque-based control system or a position-based control system. In particular, some known autonomous vehicles employ electronic power assist steering (EPAS) systems that are position-based instead of torque-based. In contrast, torque-based control is usually found in conventional mechanical steering systems.

By utilizing position-based steering control systems in these known autonomous vehicles, torque feedback that is usually encountered or felt by a driver in a conventional steering system may not be detected, thereby preventing mechanical issues and/or degradation from being known. In other words, potential problems that are usually detected when a driver uses a conventional steering system (e.g., based on steering wheel feel/feedback) may not be detected or known in autonomous control systems.

Known position-based steering control systems sometimes utilize a first proportional integral derivative (PID) controller with a velocity control loop and a second PID controller for a position control loop. However, these PID controllers may potentially have associated higher response times and/or lag. Accordingly, these known PID controllers may not effectively maintain steering control, stability and/or reject disturbances encountered during driving.

### SUMMARY

An example apparatus includes a sensor associated with a steering system to measure an operational angle of the steering system, a virtual torsion bar operatively coupled to the steering system, the virtual torsion bar to calculate a control torque based on a request angle and the operational angle, and a torque compensator to control an output torque of the steering system based on the control torque.

An example method includes determining a request angle of a steering system, measuring, at a sensor, an operational angle of the steering system, calculating, via a virtual torsion bar, a control torque based on the request angle and the operational angle, and controlling an output torque of the steering system based on the control torque.

An example non-transitory tangible machine readable medium comprising instructions, which when executed, cause a processor to at least calculate, based on a virtual torsion bar, a control torque of a steering system based on a request angle and an operational angle, and calculate an output torque of the steering system based on the control torque.

### BRIEF DESCRIPTION OF THE DRAWINGS

FIG. 1 depicts an example autonomous vehicle in which the examples disclosed herein may be implemented.

FIG. 2 is a detailed view of an example electronically controlled steering system of the example autonomous vehicle of FIG. 1.

FIG. 3 illustrates feedback control of a known electronic steering control system.

FIG. 4 illustrates feedback control of an example electronic steering system in accordance with the teachings of this disclosure.

FIG. 5 illustrates feedback control of an alternative example electronic steering system in accordance with the teachings of this disclosure.

FIG. 6 is a schematic overview of the example electronic steering system of FIG. 4.

FIG. 7 is a flowchart representative of an example method that may be used to implement the examples disclosed herein.

FIG. 8 is a flowchart representative of another example method that may be used to implement the examples disclosed herein.

FIG. 9 is a processor platform that may be used to implement the example methods of FIGS. 7 and/or 8 to implement the example steering system of FIG. 6.

FIG. 10 is an example graph depicting example torque output that illustrates how the examples disclosed herein can effectively detect vehicle pull.

FIG. 11 is an example graph depicting an example torque comparison illustrating how the examples disclosed herein can effectively detect a change in steering friction

FIG. 12 is an example graph depicting responses of known control systems in comparison to an example response corresponding to the examples disclosed herein.

The figures are not to scale. Instead, to clarify multiple layers and regions, the thickness of the layers may be enlarged in the drawings. Wherever possible, the same reference numbers will be used throughout the drawing(s) and accompanying written description to refer to the same or like parts. As used in this patent, stating that any part is in any way positioned on (e.g., positioned on, located on, disposed on, or formed on, etc.) another part, indicates that the referenced part is either in contact with the other part, or that the referenced part is above the other part with one or more intermediate part(s) located therebetween. Stating that any part is in contact with another part means that there is no intermediate part between the two parts.

### DETAILED DESCRIPTION

Methods and apparatus for virtual torsion bar steering controls are disclosed. Known electronic steering systems in vehicles typically employ either a torque-based control system or a position-based control system. Position-based steering control systems are usually utilized in autonomous vehicles and utilize a proportional integral derivative (PID) controller, which may result in lagging steering input response times.

Further, known position-based steering systems may leave mechanical issues and/or degradation undetected. In particular, potential or latent problems that are usually detected by a person using a mechanical based control system (e.g., steering wheel feel) may go undetected.

Physical torsion bars are sometimes used in known steering systems. In particular, such physical torsion bars may extend along a steering column between a steering wheel and a rack and pinion to translate a physical movement (e.g., turning the steering wheel) into rotation of a respective steering system. In particular, a twisting motion that varies based on an amount of applied torque may be translated along a physical torsion bar to control a valve that allows hydraulic fluid to flow, thereby causing an assisted movement of a rack and pinion.

The examples disclosed herein utilize a virtual torsion bar, which can be implemented as an algorithm in software, to enable a very quick steering response. In particular, the examples disclosed herein utilize a control system/algorithm that takes into account an input/desired angle, an operational/actual angle (e.g., a current steering angle), a rate of change of the input angle and a rate of change of the operational angle in conjunction with a virtual torsion bar stiffness and a virtual torsion bar damping rate to calculate and control a torque of a steering system. In this example, the virtual torsion bar is implemented as a proportional-derivative (PD) controller.

As used herein, the term “virtual torsion bar” refers to and/or encompasses an algorithm, a computation, a component, circuitry and/or a control system, etc. to calculate and/or control torque of a steering system without necessarily utilizing a physical/mechanical torsion bar. As used herein, the term “operational angle” refers to an actual or current orientation and/or a directional orientation set point of a steering system. As used herein, the term “request angle” refers to an input or desired angle associated with autonomous driving system or manual vehicle control.

As used herein, the term “operating condition” refers to an operational condition, a degree to which a system or component is operating within expected parameters, a level of degradation and/or a degree of malfunction. Accordingly, the term “operating condition” of a steering system refers to a degree to which the steering system works within or out of an expected or nominal operational status.

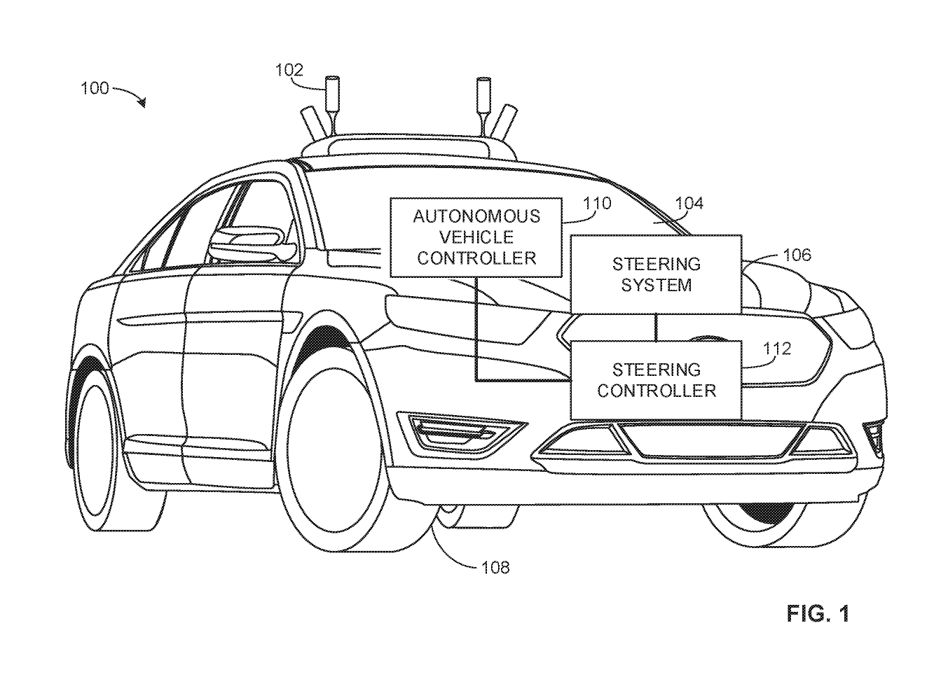

FIG. 1 is an example autonomous vehicle 100 in which the examples disclosed herein may be implemented. According to the illustrated example of FIG. 1, the autonomous vehicle 100 includes an autonomous vehicle communication system 102, which includes a wireless transceiver, a cabin 104, a wheel steering system 106, wheels 108, an autonomous vehicle controller 110 and an electronic power assisted steering (EPAS) controller 112.

To direct/guide movement of and/or navigate the example autonomous vehicle 100, the autonomous vehicle communication system 102 receives navigation and/or road condition data corresponding to the autonomous vehicle 100 such as GPS mapping data, weather condition data, road construction data, etc. In this example, sensor data received from sensors (e.g., visual sensors, proximity sensors, etc.) are processed by the example autonomous vehicle controller 110 so that the steering controller 112 can direct movement and/or orientation of the steering system 106 and, thus, direct movement of the autonomous vehicle 100.

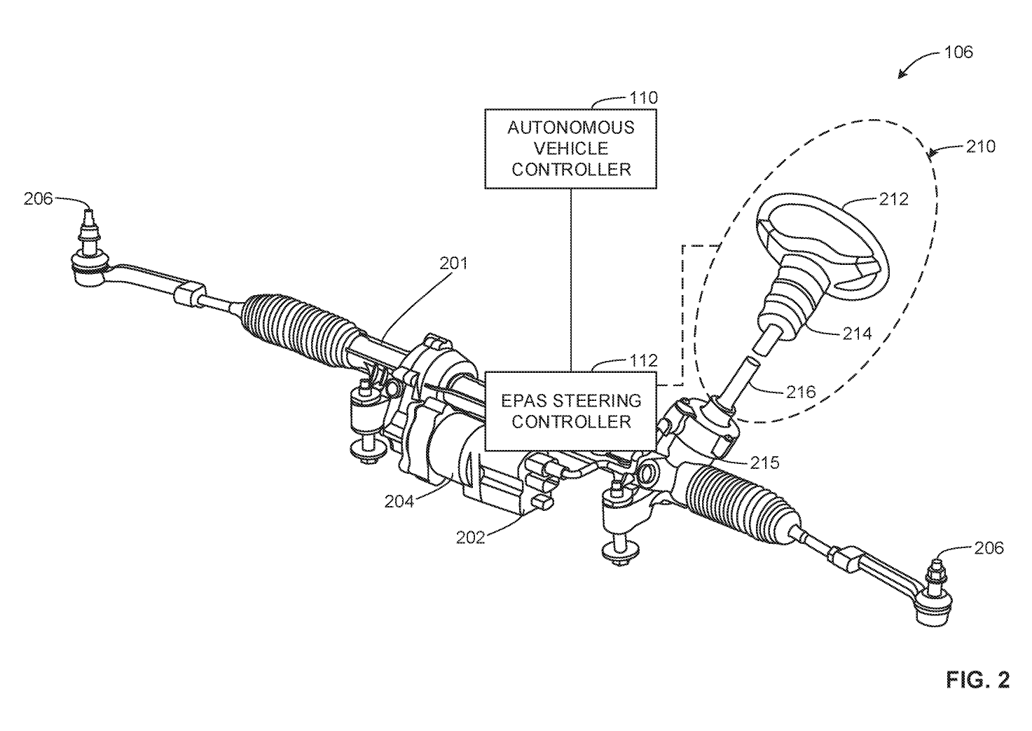

FIG. 2 is a detailed view of an example electronically controlled steering system 106 of the example autonomous vehicle of FIG. 1. As can be seen in the illustrated example of FIG. 2, the example steering system 106 is operationally coupled to both the autonomous vehicle controller 110 and the steering controller 112. In this example, the electronic steering system 106 includes a steering rack 201, a steering computer 202, which may implement the steering controller 112 in some examples, a steering motor 204 (e.g., a torque steering motor, etc.) and steering pivots (e.g., ball joints) 206 to which the wheels 108 shown in FIG. 1 are coupled.

In some examples, a mechanical steering system (e.g., a manual control steering system, a driver-operated steering system etc.) 210 is also included to provide a manual control driver interface. In such examples, the example steering system 210 includes a mechanical steering interface (e.g., a steering wheel, etc.) 212, steering hardware 214, a rack-and-pinion 215 and a steering wheel shaft 216. The example mechanical steering system 210 may be implemented to switch the autonomous vehicle 100 between self-driven and manual driving modes, for example.

To direct movement of the steering system 106 and/or turn/rotate the wheels 108, the autonomous vehicle controller 110 and/or the mechanical steering system 210 direct the steering controller 112 to cause a movement at the steering pivots 206. For example, the steering controller 112 sends a request angle (e.g., a steering request angle, input angle, etc.) and/or a torque command to the steering computer 202 which, in turn, causes movement/turning of wheels 108 at the respective steering pivots 206.

In examples where a driver provides input to the steering wheel 212, the rack-and-pinion 215 translates a manually provided twisting motion, force and/or movement of the steering wheel shaft 216 into forces measured and used by the steering computer 202 to direct an amount of force, torque and/or movement provided by the steering motor 204. In particular, the rack-and-pinion 215 translates driver/user provided torque into rack force (e.g., steering rack force, etc.) that is translated and/or computed by the steering computer 202 to compute a requested movement provided by the steering interface 212, thereby directing movement of the steering motor 204. In other words, the steering computer 202 determines, processes and/or computes manual driver inputs. In some examples, the steering wheel 212 and/or the steering controller 112 includes a steering wheel sensor to measure a rotation and/or movement of the steering wheel 212 and/or the steering wheel shaft 216.

While the examples are shown in regards to autonomous vehicles and/or partially autonomous vehicles (e.g., vehicles with optional autonomous driving), the examples disclosed herein may also be applied to non-autonomous vehicles as well (e.g., manually-driven vehicles, driver-operated vehicles, etc.).

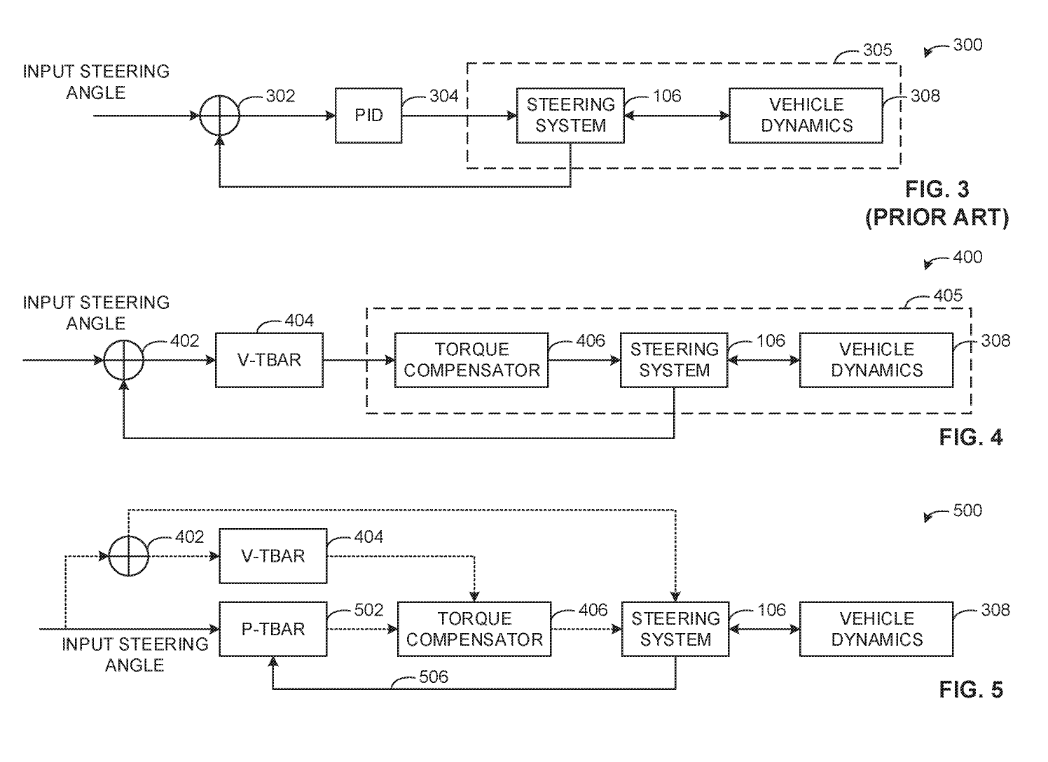

FIG. 3 illustrates feedback control of a known electronic steering system 300. The known steering system 300 is position-based and includes a data operation (e.g., a summation or additive operation) 302, a proportional integral derivative (PID) controller 304, a motor and plant transfer function section 305, which includes the example steering system 106 as well as a vehicle dynamics system 308. The PID controller 304 is implemented as multiple PID controllers including a first PID controller for a velocity loop and a second PID controller for a position loop.

To direct movement of the steering system 106, thereby steering a vehicle, the PID controller 304 receives an output position from the steering system 106 and a steering input request from the data operation 302. In this known steering system 300, rotational position of a steering motor associated with the steering system 106 as well as a velocity (e.g., a vehicle velocity or speed) is used to direct control and/or movement of the steering motor.

Implementation of the PID controller 304 to move/rotate the steering motor can have a significant associated lag time and/or relatively higher response time in response to steering input. In particular, PID turning has a trade-off involving response time and stability requirements and such a trade-off may result in sluggish response time. Further, this known implementation is not able to effectively determine mechanical degradation, malfunction(s) and/or an overall operating condition/effectiveness of the steering system 300. In contrast, the examples disclosed herein enable relatively quick steering response as well as facilitate detection or determination of potential mechanical degradation and/or malfunction.

FIG. 4 illustrates position-based feedback control of an example electronic steering system 400 in accordance with the teachings of this disclosure. The steering system 400 of the illustrated example includes a data operation (e.g., a summation or additive operation that adds or subtracts measured angles from operational angles from one another, a value forwarding operation, etc.) 402, a virtual torsion bar (e.g., a virtual torsion bar controller, a virtual torsion bar calculation device, a virtual torsion bar calculator, etc.) 404, which is implemented as a proportional-derivative (PD) controller in this example, and a plant transfer function 405. The example plant transfer function 405 includes a torque compensator 406, the aforementioned steering system 106 and the vehicle dynamics system 308 shown in FIG. 3.

According to the illustrated example, the virtual torsion bar 404 receives steering input data (e.g., positional steering and/or steering command information) from the data operation 402 as well as feedback data (e.g., operational or current steering angle/position) corresponding to the steering system 106 that is forwarded by the data operation 402 from the steering system 106. In particular, the example virtual torsion bar 404 receives an input steering angle (e.g., a desired steering angle) and an operational angle provided by the steering system 106 (e.g., a current turn position, angle and/or orientation of the steering system 106) via the data operation 402. In turn, the virtual torsion bar 404 of the illustrated example calculates a control torque (e.g., a torque request, an input torque, an equivalent torque, etc.) based on the input steering angle and the operational angle. In this example, the control torque is calculated as shown below in Equation 1:

T_{control}=(Input Angle−Operational Angle)*Virtual Torsion Bar Stiffness+(Input Angle Rate−Operational Angle Rate)*Virtual Torsion Bar Damping rate (1)

Additionally or alternatively, the virtual torsion bar 404 takes into account an output torque corresponding to the steering system 106.

To control the respective steering system 106, the example virtual torsion bar 404 operates as a PD controller and is communicatively coupled to the torque compensator 406 that converts the calculated control torque into actual operational steering torque. To effectively and efficiently calculate a control torque as a PD controller, the virtual torsion bar 404 performs this calculation based on a torsion bar stiffness (e.g., a calculated virtual equivalent torsion bar stiffness, the “P” of the PD controller is designated as torsion bar stiffness) and operates to facilitate both a low and high frequency response of the calculated control torque. In this example, operation of the virtual torsion bar 404 is based on position, positional changes and/or positional differences instead of input torque, which is commonly utilized in conventional steering control systems. In other words, the virtual torsion bar 404 utilizes position-based control, in which positional data is subsequently converted to operating torque by the torque compensator 406. Further, the virtual torsion bar 404 takes into account a rate of change of the input steering angle and a rate of change of the operational angle.

In some examples, the virtual torsion bar 404 is varied and/or adapted in response to vehicle parameters and/or settings. In particular, a frequency response and/or dampening/damping of the control torque calculated by the virtual torsion bar 404 may be varied based on the vehicle parameters, vehicle condition(s) and/or settings. For example, the virtual torsion bar 404 can alter movement characteristics/response and/or a torque of the steering system 106 based on vehicle speed, weather, driving conditions (e.g., road condition(s), construction areas, etc.) and/or a selected driving mode of the vehicle 100 (e.g., a driving mode selected by a driver or passenger of the vehicle 100 such as a comfort or sport mode, etc.) by varying at least one of the virtual torsion bar stiffness and/or the virtual torsion bar damping rate. The stiffness and damping rate of the virtual torsion bar or tuning or online adaptive changing of the stiffness and damping can be readily determined based on design/application need(s) (e.g., design optimizations) in torque-based steering. In contrast, known steering control systems that involve tuning PID controllers for both velocity and position loops may require very significant effort and/or time to tune.

To implement relatively quick feedback control and/or relatively low lag times of the steering system 106 based on the control torque computed by the virtual torsion bar 404, the torque compensator 406 of the illustrated example operates as a lead-lag compensator and calculates an amount of torque that the steering system 106 is to provide to the vehicle dynamics system 308 based on the control torque provided from the virtual torsion bar 404. Additionally or alternatively, the example torque compensator 406 may operate as a steering inertia compensator, an active damping system and/or a torque stabilizing filter, for example. In some examples, the example torque compensator 406 operates as a filter, amplifier and/or transfer function. Additionally or alternatively, the torque compensator 406 and/or the virtual torsion bar 404 determines and/or directs a rate of movement (e.g., a rate of turning, function of rotational movement with respect to time, etc.) and/or a time delay for movement of the steering system 106.

According to the illustrated example, the vehicle dynamics system 308 provides feedback and/or a response to the steering system 106. In particular, the vehicle dynamics system 308 provides a general mechanical/physical response of the vehicle 100 to the steering system 106 during driving of the vehicle 100. Additionally or alternatively, the mechanical/physical response is measured by sensors of the vehicle dynamics system 308. In some examples, the measured mechanical/physical response is provided to the virtual torsion bar 404 to vary control and/or calculation of the control torque.

In some examples, the virtual torsion bar 404 and the torque compensator 406 are integral. In some examples, the virtual torsion bar 404 is communicatively coupled to the vehicle dynamics system 308.

FIG. 5 illustrates feedback control of an alternative example electronic steering system 500 in accordance with the teachings of this disclosure. The electronic steering system 500 is similar to the example steering system 400, but also includes a physical torsion bar 502 in addition to the aforementioned virtual torsion bar 404. In particular, the physical torsion bar 502 is operatively coupled to be parallel (e.g., functionally parallel) to the virtual torsion bar 404. Further, in direct contrast to the example steering system 400 of FIG. 4, the electronic steering system 500 also includes a physical connection 506 that mechanically couples the physical torsion bar 502 to the steering system 106. In other words, in this example, the physical torsion bar 502 extends between the steering wheel 212 and the steering rack 201, thereby providing a mechanical connection between the steering wheel 212 and the rack and pinion 215 shown in FIG. 2. In some examples, the physical torsion bar 502 is integral with and/or coupled to the steering shaft 216.

In operation, the aforementioned data operation 402 receives an input and/or request steering angle, which may be physically provided by and/or translated via the physical torsion bar 502. According to the illustrated example, both the virtual torsion bar 404 and the physical torsion bar 502 provide torque values to the torque compensator 406. In this example, both the virtual torsion bar 404 and the physical torsion bar 502 provide torque to the torque compensator 406 as signals. In response to receiving torque signals from both the virtual torsion bar 404 and the physical torsion bar 502, the example torque compensator 406 determines an output torque (e.g., a scaling factor of torque values provided from the virtual torsion bar 404 and the physical torsion bar 502) which is, in turn, provided to steering components of the steering system 106. In some examples, the example steering system 106 provides physical feedback to a driver via the physical torsion bar 502, thereby providing mechanical feedback to the driver. In this example, the parallel structure/arrangement of the virtual torsion bar 404 in relationship to the physical torsion bar 502 enables advantageous control of torque provided to the torque compensator 406.

In some examples, the request/input steering angle is also provided to the steering system 106. Additionally or alternatively, the virtual torsion bar 404 and the physical torsion bar 502 are switchable between one another based on a desired operation. In such examples, at least one of the virtual torsion bar 404 or the physical torsion bar 502 is made inactive and/or turned off while the other operates. Additionally or alternatively, in some examples, a degree of control is weighted between the virtual torsion bar 404 and the physical torsion bar 502 (e.g., the virtual torsion bar 404 is given a 60% weighting while the physical torsion bar 502 is given a 40% weighting) to vary a degree to which either influences the overall control scheme. In such examples, this weighting can be varied based on driving mode, selected driving mode, speed, detected driving conditions, weather conditions and/or detected steering slippage, etc.

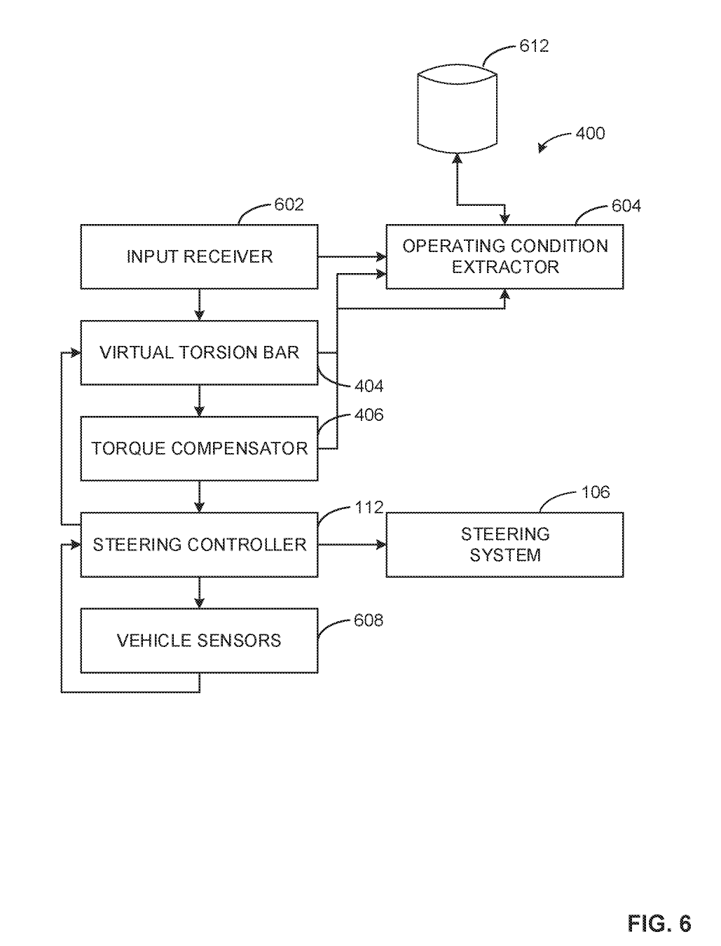

FIG. 6 is a schematic overview of the electronic steering system 400 of FIG. 4. As can be seen in the illustrated example of FIG. 6, the electronic steering system 400 includes an input receiver 602, an operating condition extractor (e.g., a condition analyzer) 604, the virtual torsion bar 404, the torque compensator 406, the steering controller 112, the aforementioned steering system 106 and vehicle sensors 608, which may include a steering angle sensor (e.g., a rotational sensor, a rotational position sensor, a wheel rotation sensor, etc.), for example. In some examples, the electronic steering system 400 also includes a database (e.g., a database of historical data and/or known degradation patterns, etc.) 612.

In operation, the example input receiver 602 receives a steering request angle, which can be received as a request or computed steering angle pertaining to autonomous vehicle driving. The steering request angle is forwarded to both the virtual torsion bar 404 and the operating condition extractor 604. As mentioned above in connection with FIG. 4, the example virtual torsion bar 404 calculates a control torque based on this request angle and a current operational angle (e.g., a current measured angle, an operating angle, a turning angle, etc.), which corresponds to the current rotational angle or orientation of the steering system 106. In turn, the torque compensator 406 receives the control torque from the virtual torsion bar 404 and calculates and/or processes signal(s) associated with the control torque to direct movement by the steering controller 112. In this example, sensor readings from the vehicle sensors 608 are provided to the steering controller 112 and/or the operating condition extractor 604 to facilitate determination of steering condition(s) and/or an overall operating condition of the steering system 106.

To determine potential degradation and/or potential malfunctions of the vehicle 100 and/or the steering system 106, the operating condition extractor 604 of the illustrated example utilizes the request/input angle, the operational or actual angle, and an output/request torque calculated by the torque compensator 406. Additionally or alternatively, the operating condition extractor 604 utilizes the control torque calculated by the virtual torsion bar 404. In this example, the operating condition extractor 604 determines an operating condition (e.g., a functional effectiveness, a degree to which the steering system 106 is working, etc.) based on comparing measurements and/or changes in measurement of the request angle, the operational angle and the output torque. Additionally or alternatively, the operating condition extractor 604 utilizes historical data and/or historical relationship values, either of which may be stored within the steering controller 112 in some examples. This historical data and/or historical relationship value(s) between any of these parameters can be stored in the database 612 and used to determine the operating condition. For example, the operating condition extractor 604 can detect a slow drift pertaining to mechanical components of the steering system 106. In some examples, the operating condition extractor forwards information/data pertaining to the slow drift to the vehicle dynamics system 308.

In some examples, the virtual torsion bar 404 and/or the torque compensator 406 adjust operation and/or operating torques of the steering system 106 based on a determined malfunction and/or degradation (e.g., a slow drift degradation). Additionally or alternatively, the operating condition extractor 604 is able to determine a type of failure and/or a direct or indirect cause of malfunction or degradation based on comparing shifting trends and/or detected drift of the request angle, the operational or actual angle, and/or the calculated control torque. In such examples, the operating condition extractor 604 may utilize a library of known malfunction or degradation signatures.

In some examples, the input receiver 602 is communicatively coupled to the autonomous vehicle controller 110. Additionally or alternatively, the input receiver 602 is communicatively coupled to the manually-operated mechanical steering system 210. In other words, the examples disclosed herein may be applied to an autonomous vehicle, a manually driven vehicle, or a combination of both.

In some examples, a response behavior of the virtual torsion bar 404 and/or an equivalent stiffness of the virtual torsion bar 404 is varied based on sensor data received from the vehicle sensors 608, such as, but not limited to, vehicle speed, a selected driving mode (e.g., a driving mode selected by a driver and/or passenger), detected traffic conditions, weather conditions, learned steering control patterns of a person, detected or determined environmental conditions, a detected grade/slope/contour of a road and/or detected road condition(s), such as roughness, imperfections, pot holes, etc.

In some examples, the virtual torsion bar 404 is not present while the operating condition extractor 604 is used to determine an operating condition based on the input angle, the operational angle and the operational/request torque. In other words, in such examples, the examples disclosed herein are used primarily to determine an operating condition.

While an example manner of implementing the example steering control system 400 of FIG. 4 is illustrated in FIG. 6, one or more of the elements, processes and/or devices illustrated in FIG. 6 may be combined, divided, re-arranged, omitted, eliminated and/or implemented in any other way. Further, the example autonomous vehicle controller 110, the example steering controller 112, the steering computer 202 the example torsion bar 404, the example torque compensator 406, the example input receiver 602, the example operating condition extractor 604 and/or, more generally, the example steering control system 400 of FIG. 4 may be implemented by hardware, software, firmware and/or any combination of hardware, software and/or firmware. Thus, for example, any of the example autonomous vehicle controller 110, the example steering controller 112, the steering computer 202 the example torsion bar 404, the example torque compensator 406, the example input receiver 602, the example operating condition extractor 604 and/or, more generally, the example steering control system 400 of FIG. 4 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, autonomous vehicle controller 110, the example steering controller 112, the steering computer 202 the example torsion bar 404, the example torque compensator 406, the example input receiver 602, and/or the example operating condition extractor 604 is/are hereby expressly defined to include a non-transitory computer readable storage device or storage disk such as a memory, a digital versatile disk (DVD), a compact disk (CD), a Blu-ray disk, etc. including the software and/or firmware. Further still, the example steering control system 400 of FIG. 4 may include one or more elements, processes and/or devices in addition to, or instead of, those illustrated in FIG. 6, and/or may include more than one of any or all of the illustrated elements, processes and devices.

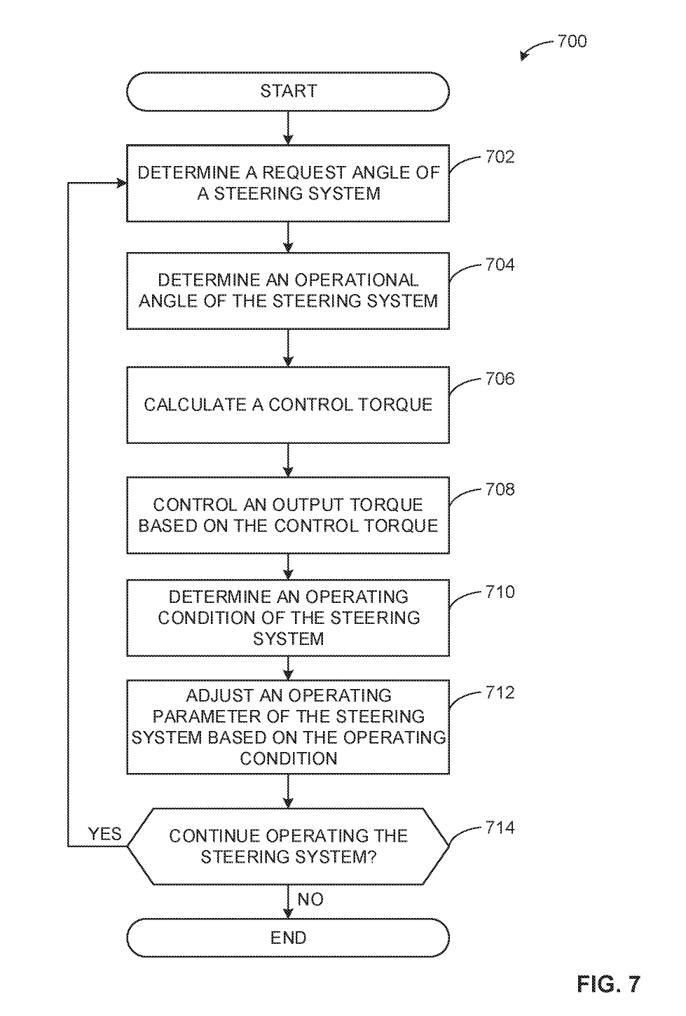

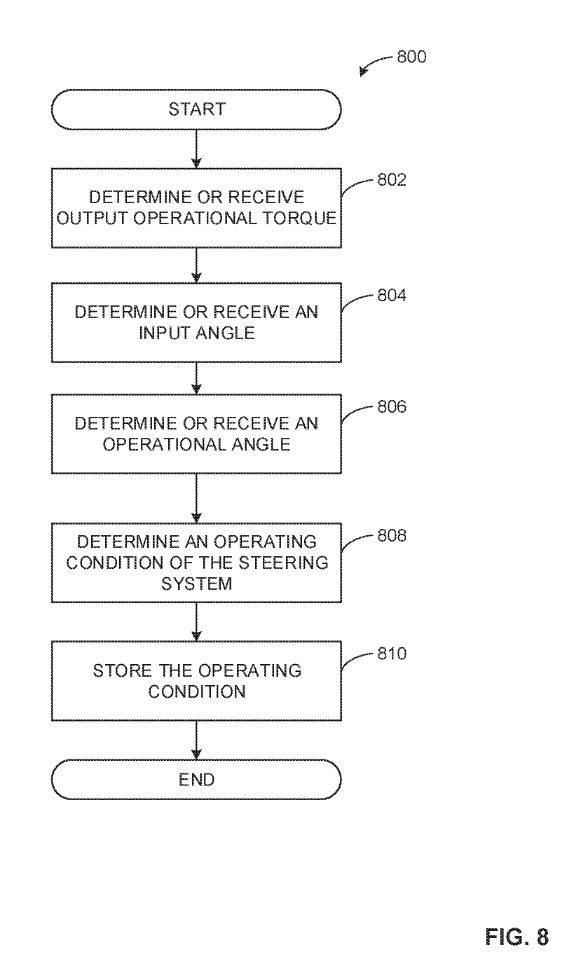

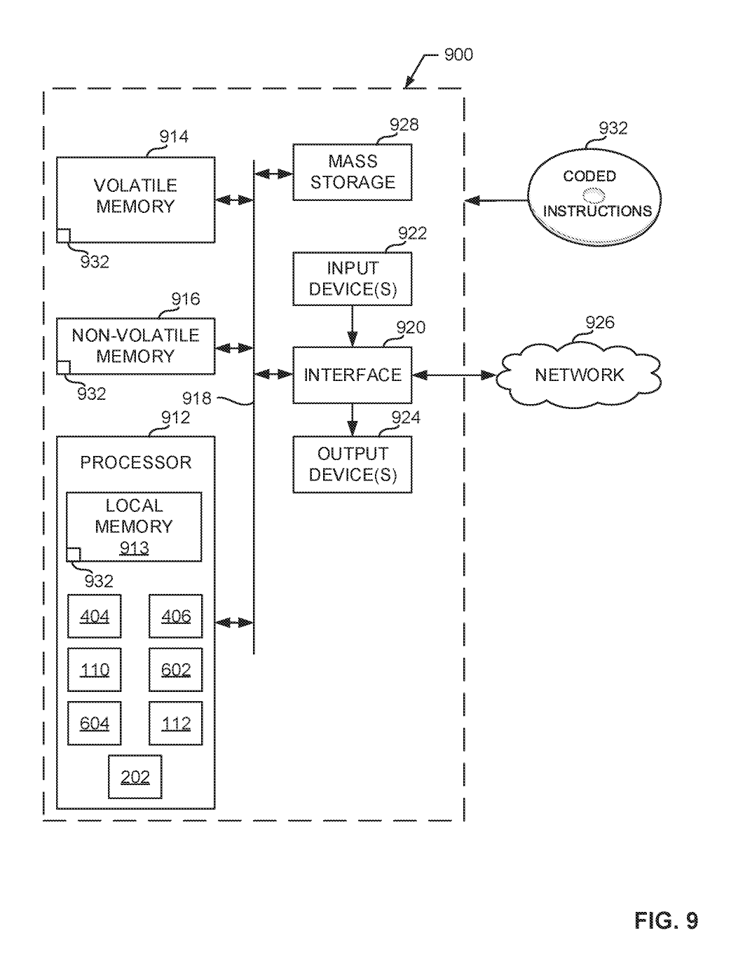

A flowchart representative of example machine readable instructions for implementing the steering control system 400 of FIG. 4 is shown in FIGS. 7 and 8. In this example, the machine readable instructions comprise a program for execution by a processor such as the processor 912 shown in the example processor platform 900 discussed below in connection with FIG. 9. The program may be embodied in software stored on a non-transitory computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowcharts illustrated in FIGS. 7 and 8, many other methods of implementing the example steering control system 400 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, a Field Programmable Gate Array (FPGA), an Application Specific Integrated circuit (ASIC), a comparator, an operational-amplifier (op-amp), a logic circuit, etc.) structured to perform the corresponding operation without executing software or firmware.

As mentioned above, the example methods of FIGS. 7 and 8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. “Including” and “comprising” (and all forms and tenses thereof) are used herein to be open ended terms. Thus, whenever a claim lists anything following any form of “include” or “comprise” (e.g., comprises, includes, comprising, including, etc.), it is to be understood that additional elements, terms, etc. may be present without falling outside the scope of the corresponding claim. As used herein, when the phrase “at least” is used as the transition term in a preamble of a claim, it is open-ended in the same manner as the term “comprising” and “including” are open ended.

The example method 700 of FIG. 7 begins as the steering system 106 is being operated during driving of the autonomous vehicle 100. In particular, the steering system 106 is being controlled and/or directed by the autonomous vehicle controller 110 in an automated driving mode to navigate the vehicle 100.

According to the illustrated example, the input receiver 602 determines and/or receives a request angle pertaining to a desired or computed movement of the steering system 106 (block 702). In this particular example, the autonomous vehicle controller 110 directs movement of the steering system 106 via transmission of input signals (e.g., steering commands) to the input receiver 602. In this example, the input signals are forwarded to the virtual torsion bar 404. In some examples, the input receiver 602 is operatively coupled to a manually controlled steering system such as the mechanical steering system 210 shown in FIG. 2.

In this example, the steering controller 112 determines an operational angle of the steering system 106 (block 704). The steering controller 112 can utilize a current set point angle of the steering system 106 (e.g., a current angular setting or position of the steering system 106) and/or a measured angle of the steering system 106 via a positional sensor (e.g., a steering rack sensor, a wheel sensor, etc.). Additionally or alternatively, the steering controller 112 measures a rate of change/movement of the steering system 106.

The virtual torsion bar 404 of the illustrated example calculates a control torque (block 706). As described above in connection with FIG. 4, the virtual torsion bar 404 calculates the control torque based on the operational angle and the request angle. In this example, the virtual torsion bar 404 also takes into account a rate of change of the request angle and/or the operational angle.

According to the illustrated example, the torque compensator 406 then controls an output torque of the steering system 106 based on the calculated control torque (block 708). In this example, torque compensator 406 acts to amplify the control torque by at least an order of magnitude to direct movement of the steering system 106.

In some examples, the operating condition extractor 604 is used to determine an operating condition of the steering system 106 (block 710). In particular, the operating condition extractor 604 may utilize historical and/or recorded data to determine that the steering system 106 and/or components associated with the steering system 106 are encountering a drift from nominal operating conditions.

In some examples, an operating parameter of the steering system 106 is adjusted based on the determined operating condition (block 712). In particular, in response to a determination by the operating condition extractor 604, the steering controller 112 and/or the virtual torsion bar 404 may direct the torque compensator 406 to account for degradation such as a drift (e.g., a drift occurring over an extended period of time) or bias of the steering system 106, for example.

Next, it is determined whether to continue operating the steering system 106 (block 714). If it is determined to continue operating the steering system 106 (block 714), control of the process returns to block 702. Otherwise, the process ends.

The example method 800 of FIG. 8 begins as an operating condition of the steering system 106 (e.g., a degree to which the steering system 106 is operating normally, etc.) is to be evaluated as the autonomous vehicle 100 is being driven. In particular, the vehicle 100 is being driven and the condition extractor 604 is being used to determine an operating condition of the steering system 106.

In this example, an output operational torque from the torque compensator 406 and/or the steering controller 112 is determined/measured and/or received (e.g., from a sensor of the steering system 106) (block 802).

In this example, a request/input angle is determined or received (block 804). For example, the input receiver 602 receives a requested input angle from the autonomous vehicle controller 110 while the autonomous vehicle controller 110 directs movement/driving of the vehicle 100.

Next, an operational angle of the steering system is determined or received (block 806). In particular, the example steering controller 112 is communicatively coupled to a positional sensor that measures an angle or rotation of the wheels 108.

According to the illustrated example, the operating condition extractor 604 then determines the operating condition of the steering system 106 (block 808). The operating condition extractor 604 of the illustrated example makes this determination based on the request/input angle the operational angle, and the output operational torque of the steering system 106. Additionally or alternatively, sensor data from the vehicle sensors 608 is also used. In some examples, the control torque calculated by the virtual torsion bar 404 is used in this determination.

In some examples, the operating condition is stored in the database 612 (block 810) and the process ends. In particular, the operating condition extractor 604 may store data related to determined operational conditions and/or associated numerical values in the database 612 and/or the steering controller 112 so that a drift analysis and/or a gradual long-term shift of the steering system 106 may be determined. In other words, data pertaining to the operating condition can be stored in the database 612 to facilitate a long-term analysis of the steering system 106.

FIG. 9 is a block diagram of an example processor platform 900 capable of executing instructions to implement the methods of FIGS. 7 and 8 and the steering control system 400 of FIG. 6. The processor platform 900 can be, for example, a server, a personal computer, a mobile device (e.g., a cell phone, a smart phone, a tablet such as an iPad), a personal digital assistant (PDA), an Internet appliance, a DVD player, a CD player, a digital video recorder, a Blu-ray player, a gaming console, a personal video recorder, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. The hardware processor may be a semiconductor based (e.g., silicon based) device. In this example, the processor implements the example, autonomous vehicle controller 110, the example steering controller 112, the steering computer 202 the example torsion bar 404, the example torque compensator 406, the example input receiver 602 and the example operating condition extractor 604.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives.

Coded instructions 932 to implement the methods of FIGS. 7 and 8 may be stored in the mass storage device 928, in the volatile memory 914, in the non-volatile memory 916, and/or on a removable tangible computer readable storage medium such as a CD or DVD.

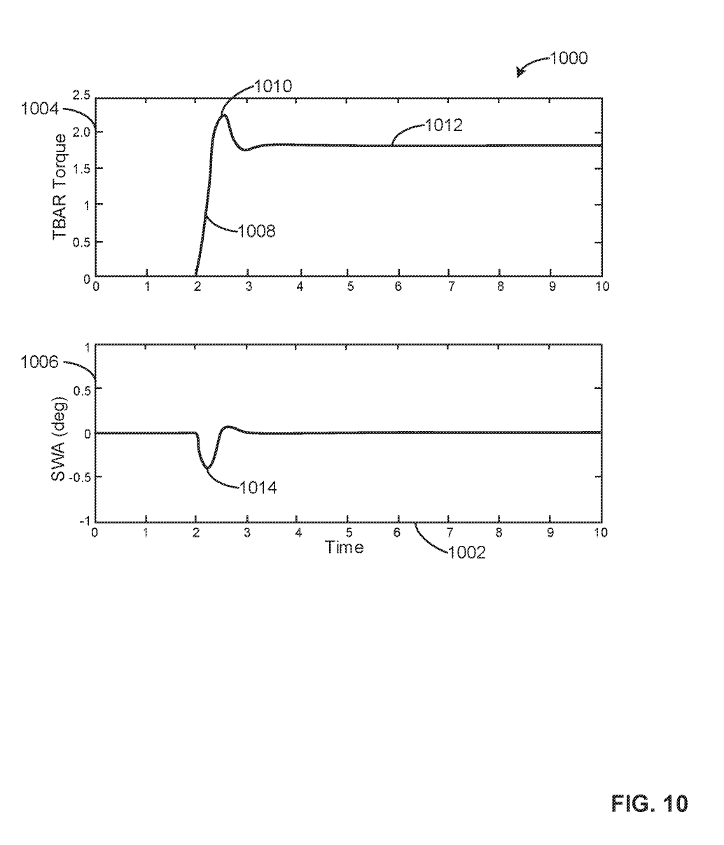

FIG. 10 is an example graph 1000 depicting example virtual torsion bar torque output that illustrates how the examples disclosed herein can effectively detect vehicle pull. The example graph 1000 includes a horizontal axis 1002, which represents time, and a first vertical axis 1004 that represents virtual torsion bar torque as well a second vertical axis 1006 that represents a steering wheel angle (SWA) measured in degrees.

As can be seen in the graph 1000, a change in steering wheel angle that is indicated by a region 1014 causes a steep rise in torque, which is shown as region 1008. The rise or increase in torque culminates in a peak 1010 and a relatively steady torque region 1012, which represents torque output for a vehicle pull (e.g., a vehicle being pulled consistently to a particular side). Such behavior indicates how virtual torsion bars in accordance with the teachings of this disclosure may be used to diagnose potential issues that would otherwise not be diagnosed, especially in an automated system such as an autonomous vehicle. Further, the examples disclosed herein can detect subtle change that are usually imperceptible during driving.

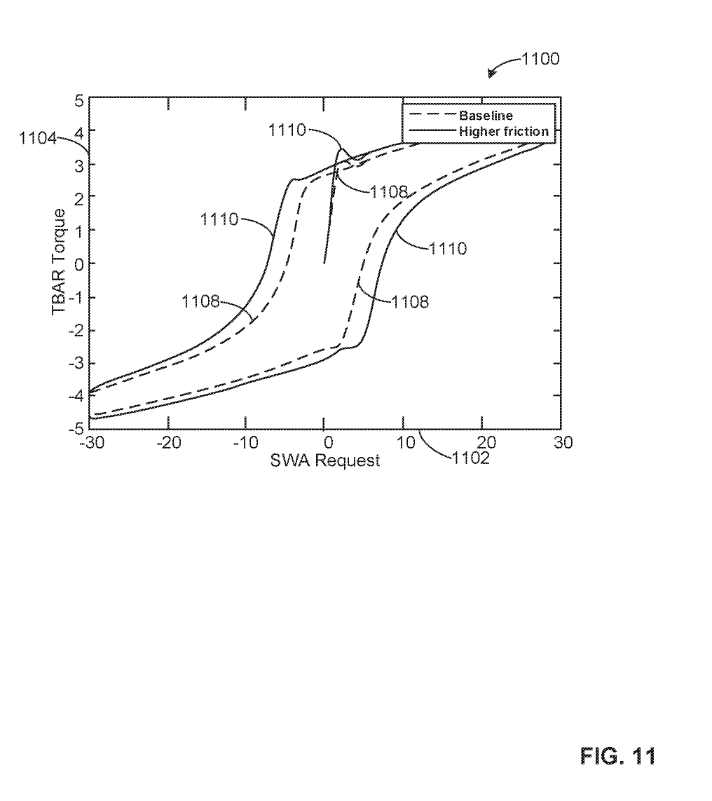

FIG. 11 is an example graph 1100 depicting an example torque comparison that illustrates how the examples disclosed herein can effectively detect a change in steering friction. The example graph 1100 includes a horizontal axis 1102, which represents a steering wheel angle (SWA) request and a vertical axis 1104, which represents a virtual torsion bar torque.

According to the illustrated example, a curved profile 1108 represent normal operation of a steering system while a curved profile 1110 represent the steering system with increased friction. As can be seen in FIG. 11, the virtual torsion bar torque can exhibit very distinct behavior, thereby demonstrating that calculations of control torque performed by a virtual torsion bar can be very effective in evaluating potential degradation and/or malfunction of steering systems. In this particular example, the virtual torsion bar indicates an increase in friction.

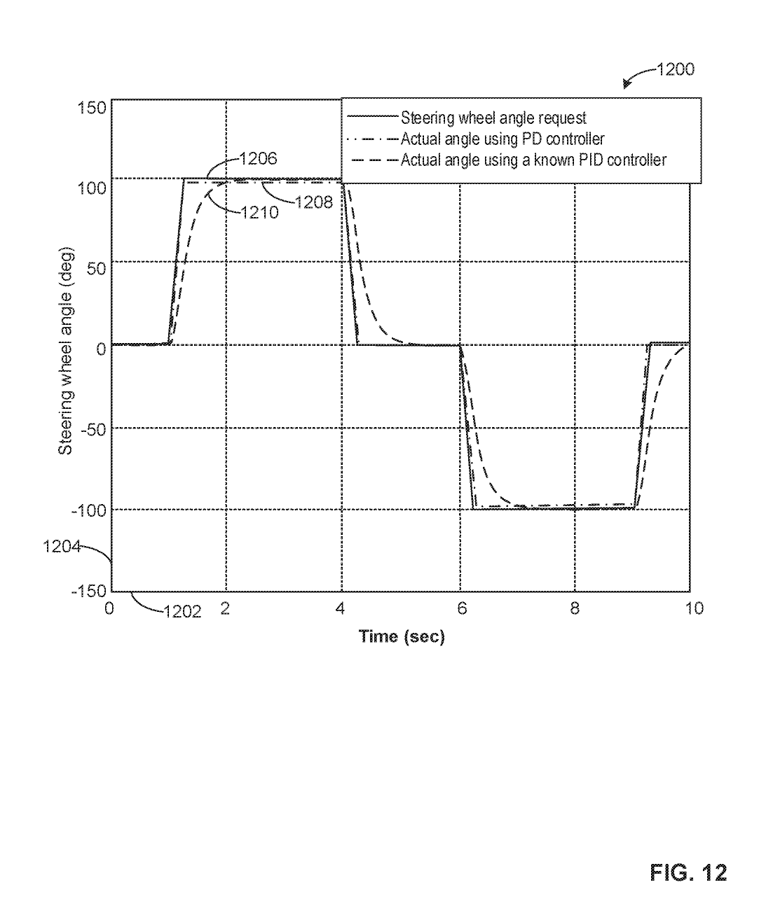

FIG. 12 is an example graph 1200 depicting a response of a known control system in comparison to an example response in accordance with the examples disclosed herein. The graph 1200 illustrates a difference in performance of virtual torsion bars of the illustrated examples with PD controllers in contrast to conventional systems using known PID controllers.

The graph 1200 includes horizontal axis 1202 depicting time (in seconds) and a vertical axis 1204 depicting a steering wheel angle response (in degrees). Further, the graph 1200 includes a curve 1206, which corresponds to a steering wheel angle request (e.g., an actual steering request), a curve 1208 pertaining to a response of a PD steering controller and/or a virtual torsion bar, as utilized in the examples disclosed herein, and a curve 1210 that corresponds to a known conventional PID steering controller. As can be seen in FIG. 12, the curve 1208 matches the curve 1206 significantly closer than the curve 1210, which appears to have a significant lag. Accordingly, the examples disclosed herein have relatively quick response times as well as greater accuracy in comparison to known systems.

From the foregoing, it will be appreciated that example methods, apparatus and articles of manufacture have been disclosed that enable effective and responsive steering controls. Further, the examples disclosed herein also enable effective and accurate determination of steering system operating conditions, which may indicate steering system mechanical conditions and/or potential degradation of steering system.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent. While the examples disclosed herein are shown related to vehicles (e.g., automobiles), the examples disclosed herein may be applied to any appropriate steering or vehicle control application.

What is claimed is:

1. An apparatus comprising
a sensor associated with a steering system to measure an operational angle of the steering system;
a virtual torsion bar operatively coupled to the steering system, the virtual torsion bar to calculate a control torque based on a request angle and the operational angle; and
a torque compensator to control an output torque of the steering system based on the control torque.

2. The apparatus as defined in claim 1, further including a condition analyzer operatively coupled to the virtual torsion bar to determine an operating condition of the steering system.

3. The apparatus as defined in claim 2, wherein the condition analyzer determines the operating condition at least partially based on the control torque.

4. The apparatus as defined in claim 1, wherein at least one of a stiffness of the virtual torsion bar or a damping rate is varied based on a vehicle condition.

5. The apparatus as defined in claim 1, further including a steering wheel sensor to measure the request angle and provide the request angle to an input receiver associated with the steering system.

6. The apparatus as defined in claim 1, further including an input receiver that is operationally coupled to an autonomous driving system to receive the request angle.

7. The apparatus as defined in claim 1, wherein the virtual torsion bar includes a proportional-derivative (PD) controller.

8. The apparatus as defined in claim 7, wherein the virtual torsion bar calculates the control torque based on a rate of change of the operational angle.

9. The apparatus as defined in claim 7, wherein the virtual torsion bar calculates the control torque based on a rate of change of the request angle.

10. A method comprising:
determining a request angle of a steering system;
measuring, at a sensor, an operational angle of the steering system;
calculating, via a virtual torsion bar, a control torque based on the request angle and the operational angle; and
controlling an output torque of the steering system based on the control torque.

11. The method as defined in claim 10, further including determining an operating condition of the steering system based on the request angle, the operational angle and an output torque of the steering system.

12. The method as defined in claim 11, wherein determining the operating condition of the steering system is further based on the control torque.

13. The method as defined in claim 10, further including varying at least one of a stiffness of the virtual torsion bar or a damping rate based on a vehicle condition.

14. The method as defined in claim 10, wherein the virtual torsion bar includes a proportional-derivative (PD) controller.

15. The method as defined in claim 10, wherein calculating the control torque is based on a rate of change of the operational angle.

16. The method as defined in claim 10, wherein calculating the control torque is based on a rate of change of the request angle.

17. A non-transitory tangible machine readable medium comprising instructions, which when executed, cause a processor to at least:
calculate, based on a virtual torsion bar, a control torque of a steering system based on a request angle and an operational angle; and
calculate an output torque of the steering system based on the control torque.

18. The machine readable medium as defined in claim 17, wherein the instructions cause the processor to determine an operating condition of the steering system based on the request angle, the operational angle and the output torque of the steering system.

19. The machine readable medium as defined in claim 18, wherein the determination of the operation condition is further based on the control torque.

20. The machine readable medium as defined in claim 17, wherein the instructions cause the processor to vary at least one of a stiffness or a damping rate of the virtual torsion bar based on a vehicle condition.

21. The machine readable medium as defined in claim 17, wherein the calculation of the control torque is based on a rate of change of at least one of the operational angle or the request angle.

22. The machine readable medium as defined in claim 17, wherein the request angle is to be received from a steering wheel.

23. The machine readable medium as defined in claim 17, wherein the request angle is to be received from an autonomous vehicle controller.
